(19) United States
(12) Patent Application Publication
(10) Pub. No.: US 2026/0140522 A1
(43) Pub. Date: May 21, 2026

(54) ULTRASONIC METHOD AND SYSTEM FOR FLUID QUALITY MEASUREMENT, CLASSIFICATION, AND MONITORING

(71) Applicant: Eugene B. SILVERMAN, Frostburg, MD (US)

(72) Inventor: Eugene B. SILVERMAN, Frostburg, MD (US)

(21) Appl. No.: 19/445,204

(22) Filed: Jan. 9, 2026

Related U.S. Application Data
(63) Continuation-in-part of application No. 17/411,605, filed on Aug. 25, 2021, now Pat. No. 12,546,751.
(60) Provisional application No. 63/069,996, filed on Aug. 25, 2020.

(51) Int. Cl. G05D 7/06; G01B 17/02; G01F 1/667; G01M 3/28

(52) U.S. Cl. CPC G05D 7/0623; G01B 17/02; G01F 1/667; G01M 3/2807

(57) ABSTRACT

A method includes insonifying, using at least one transducer, a vessel using first ultrasound energy of a first frequency, receiving, using the at least one transducer, a first analogue signal obtained using the first ultrasound energy, determining, using processing circuitry, a first material property of the vessel based on a first frequency response signature of the first analogue signal, insonifying, using the at least one transducer, a fluid in the vessel using second ultrasound energy of a second frequency lower than the first frequency, the second ultrasound energy creating cavitation of bubbles in the fluid to be measured, receiving a second analogue signal obtained using the second ultrasound energy and energy created by the cavitation of the bubbles in the fluid, and identifying a second material property of the fluid based on the first material property and a second frequency response signature of the second analogue signal.

### CROSS REFERENCE TO RELATED APPLICATIONS

This application is a continuation-in-part of application Ser. No. 17/411,605, filed on Aug. 25, 2021, 35 U.S.C. 153(b), the contents of which are incorporated by reference herein. This application claims the benefit of U.S. provisional application No. 63/069,996, filed Aug. 25, 2020, under 35 U.S.C. 119(e), the contents of which are incorporated herein by reference.

### FIELD OF INVENTION

This application is directed to the use of ultrasound energy to measure, identify, and monitor fluids that flow through or are contained within a pipe, tank or similar vessel.

### BACKGROUND

Determining the quality and purity of fluids is a critical product performance variable associated with a wide variety of industries including, but not limited to, consumer products, industrial chemicals, medical products, cosmetics, pharmaceuticals, and chemical manufacturing. Further to this quality control objective is the need for accurate, reliable and cost effective sensor systems that detect and quantify the presence and concentration of contaminants and unwanted solids within liquids used for industrial processes. The need for precise and reliable measurement and control of fluid quality is pervasive throughout the manufacturing world.

Proper quality control of fluids also depends on the ability to monitor and control the composition of liquid process streams including the distribution and size of particles. Additionally, the control of filtration operations is crucial within the mineral processing industry. Equally important is the preparation and control of feed streams within the pulp and paper industry, which depends on the ability to monitor and control the size of particles that are components of fluid process streams. The need for monitoring, measuring and controlling multiphase fluid streams is significant within the oil and gas industry. Instrumentation is used to control 3-phase separation processes for splitting production oil, water, and inorganic contaminants from off-shore oil production streams. Although there are numerous examples regarding the need for reliable and accurate measurements of fluid quality, the following discussion focuses on the need for detecting and measuring water contamination, media viscosity and percent solids within a wide range of fluids. As used herein, “fluid” means a liquid tending to flow or to conform to the outline of its container, and it is intended to include liquids that contain solids, i.e., liquid-solid mixtures that contain solid particles, whether homogeneous or heterogeneous.

To protect gas and diesel engine integrity, as well as to maintain emissions quality, it is necessary to detect water contamination in consumer and commercial fuel delivery systems. There is a need for the detection, measurement, and control of water contamination in fuel tanks servicing standby power generation plants in support of communication towers, data centers, and medical facilities. Readiness of standby diesel generators are impacted by fuel quality. Thus, it is necessary to control condensation in generators standing idol for long periods of time between cleaning cycles. Water mixed with fuel damages diesel engines. Additionally, water in turbine lubricant storage tanks destroys moving parts, alters the viscosity of lubricants, and causes chemical changes resulting in additive depletion and specification changes. Water also corrodes storage tank bottoms.

There is a range of known techniques for detecting and measuring water contamination in fuel systems. These include infrared spectroscopy, crackle and calcium hydride tests, Fischer methods, saturation meters, and acoustic methods.

Infrared (IR) spectroscopy uses a spectrometer that emits an incident light beam that passes through the media under investigation. The transmitted light is collected by a detector and is displayed as a color spectrum. The color spectrum represents the transmitted or absorbed light as a function of the wavelength of the incident beam. IR spectroscopy is often used to identify structures because functional groups give rise to characteristic bands both in terms of intensity and position (frequency).

The crackle test, which is a non-real time test, is conducted by simply dropping fuel or lubricant samples onto a hot plate. If the oil sample contains water, the sample bubbles, “crackles,” and “pops.” The crackle test is qualitative and does not precisely measure the amount of water present in an oil fluid.

The calcium hydride test is a non-real time field test that uses a known volume of oil placed in a sealed container with a known amount of calcium hydride. The container is shaken vigorously causing the water in the oil to react with the calcium hydride to produce hydrogen gas. The extent of the hydrogen off-gas is measured and converted to an approximate measure of water content in the sample.

A widely known non-real time method for detecting water in oil is by Karl Fischer coulometric titration. When conducted by a trained technician, the Karl Fischer analysis for water yields highly accurate and repeatable results and is considered a reliable analytical technique for determining water contamination. Also, the water can be measured in different forms such as dissolved within another liquid compound, freely separated from a compound, or emulsified after mixing.

Another technique for determining water quality is the use of relative humidity (RH) or saturation sensors. These sensors are used in a variety of industries where the humidity needs to be controlled, such as food services and pharmaceutical manufacturing facilities.

All of the foregoing procedures tend to function in non-real-time and lack varying degrees of accuracy that may be required for many manufacturing processes. This is also true for the measurement of fluid viscosity.

Viscosity is a quantity which relates to the flow of matter. The most common techniques for determining the viscosity of fluid involve the use of sensors in the nature of viscometers and rheometers. These techniques require an air/solution interface, which can cause erroneously high viscosity measurements. Within many industrial processes there is a critical need to control batch-to-batch consistency. For this purpose, flow behavior is considered an indirect measure of product consistency and quality. Rheometers are designed to determine a fluid's resistance to flow.

Rheometers are typically used for fluids that may have multiple layers of resistance due to the fluid's homogeneity or lack of homogeneity. Commercial limitations inherent in the use of rheometers relate to the influence of temperature variations, lack of accuracy, and non-real-time operations. Consequently, such limitations make rheometers unsuitable for real-time process control applications.

The measurement of solids concentration is also challenged with problems of accuracy and timeliness. The precise measurement of solids concentration in fluids is difficult to achieve. This is especially the case for solutions that lack homogeneity of suspended particle size and general composition. However, there are a number of general techniques for measuring total solids content in fluids. These techniques include the measurement of fluid volume by weight with or without solids, the use of mass spectrometry, and the use of nuclear magnetic resonance (NMR) techniques.

For the case of solids concentration by weight, total solids content in a liquid is typically expressed as a ratio of weights obtained before and after the fluid/solids media drying process. Measurements are typically made under controlled circumstances of temperature and time. Microwave techniques have also been demonstrated to achieve the same objective.

Measuring solids concentration within a fluid can also be accomplished using a mass spectrometer. Mass spectrometers produce charged particles (ions) from the chemical substances within the fluid's molecular structure. Mass spectrometers use electric and magnetic fields to measure the mass (“weight”) of the charged particles. Significant limitations exist with mass spectrometer instrumentation including cost and complexity.

As noted above, NMR is a chemical analytical technique used to assay the composition and chemical structure of solutions, solids and mixtures. Solid/liquid samples are subjected to magnetic fields (generated by radio waves) which result in the excitation of the nuclei within the sample resulting in magnetic resonances that are detected by radio receivers. Unique magnetic characteristics are associated with specific compounds including the ratios between the compound and the surrounding fluids. Significant limitations exist with the use of NMR instrumentation including their complexity and cost. Due to the instrument's generation of radio frequency energy, certain safety precautions limit the availability for use by the general public.

As has been shown, there are a number of drawbacks with the use of conventional measurement techniques for detecting and measuring water contamination, media viscosity, and percent solids content in a wide range of fluids. Most techniques do not operate in real time and many are found, for the most part, within a laboratory setting.

One measurement technology that has been shown to improve quality control of fluids is the use of acoustics. Although acoustic techniques are commonly used for the measurement of flow in a wide variety of pipe and piping structures (for instance, U.S. Pat. Nos. 6,575,043 and 8,489,342) there are a number of applications where acoustic techniques have been used to characterize materials. For instance, the use of acoustics for measuring water contamination has been demonstrated by Greenwood (U.S. Pat. Nos. 6,877,375 and 7,140,239) who measured ultrasonic attenuation using reference signals compared to real-time in-situ processes and by Sinha (U.S. Pat. No. 8,176,783) based on ultrasonic signal attenuation. Kashid (U.S. Pat. No. 10,801,428) applies the acoustic speed of sound and signal attenuation in fuel in order to estimate ethanol content. The use of acoustics for measuring solid concentration (and particle size and composition) has been demonstrated by Suslick, et al. (U.S. Pat. No. 9,855,538) by measuring ultrasonic attenuation using a reference signal. Prakask (CA 2761431 A1) demonstrates the use of the attenuation of an ultrasonic signal for determining particle size. Riebel (U.S. Pat. No. 4,706,509) uses ultrasound for measuring solids concentration and particle size in fluids as well. Tohidi (US 2008/0041163 A1) has shown that ultrasound can be used for precise particle detection and sizing. Glad (U.S. Pat. No. 5,255,564) demonstrates the use of the speed of sound for determining the identity of liquids. Moradi (US 2010/0063393) shows that ultrasound time and frequency domain signals can be used for detecting, diagnosing and assessing cancer and related abnormalities in biological tissue.

The use of acoustics for measuring fluid viscosity has also been demonstrated by Kruger (WO 2007/003058 A1) by measuring ultrasonic attenuation using a reference signal and by Heim (WO 2020/264497) based on the attenuation of an ultrasonic signal. Wenman, et al. (PCT WO 02/16924 A1) has shown that a standing wave interferometry method can be used to measure sub-micrometer particles associated with carbon concentrations in used engine oil, and Povey et al. (EP 1 092 976 A3) shows a method for the use of ultrasound related to “acoustic speckle” signals reflected from particles within opaque liquids.

Although these references may share some features with the technology in the present invention e.g., each uses acoustics to determine fluid quality, the similarities end there. Fluid quality measurement techniques in use today and discussed above are difficult to use, lack accuracy and repeatability, are not robust when used outside of the laboratory, and the equipment is difficult to calibrate and to keep calibrated. As a result, there remains a need for improved quality control of fluids, improved solids detection, and more precise detection and measurement of contamination within a wide range of industrial settings.

### SUMMARY

This application addresses the limitations and shortcomings of current technologies for determining and monitoring fluid quality by using acoustic energy in the ultrasonic domain to insonify fluids and suspended particles in fluids, thereby creating heat and pressure waves, and ultimately bubbles, due to acoustic cavitation. Gas and oxygen are drawn out of the bubbles located within the microstructure of the fluid and suspended materials. The acoustics associated with the collapsing bubbles create acoustic signatures in the frequency domain distinctly associated with the characteristics of the fluid, including fluid density as well as diluted and non-diluted contaminants such as suspended solids.

Acoustic profiles of fluids are created by (1) using ultrasound energy to insonify fluids and fluid-solid mixtures, thereby creating an ultrasound signature in the time domain, (2) converting the ultrasound time domain energy into the frequency domain, and (3) creating a frequency domain response for specific fluid samples, labeled as a unique frequency response signature. The unique frequency response signatures can be compiled into a frequency response signature library, which can be used to train an artificial neural network (ANN) to identify and classify future fluid samples in real time.

The method uses a multi-layered real-time process that integrates the acoustic profile of insonified fluids, employs an artificial neural network (ANN) for identifying and classifying unique acoustic profiles, and uses the classification results to (1) create an analogue or digital display regarding fluid quality, and (2) regulate a process for controlling an industrial component such as a valve or pump.

One aspect of the invention is a method for measuring fluid quality by insonifying a fluid to be measured using ultrasound energy over a period of time, thereby creating a time domain ultrasound signature; converting the time domain ultrasound signature into the frequency domain, resulting in a frequency response signature; and matching the frequency response signature to a unique identifying frequency response signature of a solid or contaminant to be identified.

A second aspect of the invention is a method for measuring fluid quality by insonifying a fluid to be measured using ultrasound energy over a period of time, thereby creating a time domain ultrasound signature; converting the time domain ultrasound signature into the frequency domain, resulting in a frequency response signature; creating a frequency response signature library comprising frequency response signatures corresponding to impurities in fluid samples that have been measured; training an artificial neural network (ANN) to identify and classify future fluid samples in real time; and correlating the frequency response signature from the fluid being measured to the frequency response signature library to identify impurities in the fluid.

A third aspect of the invention is a system for determining product quality within a fluid media, including a piezoelectric signal emitter transducer; a piezoelectric signal receiver transducer; transducers located from 0 degree to 180 degree from each other (or within a 180 degrees half-concentric circle from the transmitting transducer); transducers connected to electronics that provide pulse and receive signal power; a computer with analogue-to-digital converter capabilities; computing capability for digitizing, filtering and processing the signal from the analogue-to-digital converter; and computer hardware and software for controlling the functioning of a valve or pump.

A fourth aspect of the invention is an ultrasonic-based fluid quality measurement, classification, and quality monitoring system having one or more ultrasound transmitting and receiving transducers operating in a single frequency pulse echo or multiple frequency chirp mode but not confined to a single frequency or particular range of frequencies; software and firmware to convert time domain ultrasound data into the frequency domain in the form of an FFT; software and firmware for (i) establishing a computer database of FFT signatures associated with different fluids and fluid characteristics, e.g., with different concentrations of suspended solids creating different degrees of fluid turbidity; (ii) creating a real-time data stream or base of FFT signatures associated, by example, with the real-time acquisition of FFT signatures from fluids; (iii) comparing a data stream or data base of FFT signatures to a previously stored FFT signature data base in order to identify and classify particular fluids or fluid characteristics.

A feature of the invention is the use of machine learning algorithms for the identification, measurement, and classification of the unique composition of a fluid including the detection and quantification of contaminants. The results of the signature classification results can occur in real time in order to control valves and pumps typically found within a range of process-control industries.

Another feature of the invention is that it can include an analogue or digital user display.

Another feature of the invention is that it can provide for the control of a discrete or proportional valve or similar mechanical operator.

Another feature of the invention is that it can interface to the Internet and be controlled remotely.

Another feature of the invention is that it can be packaged for a fixed location or it can be portable.

Another feature of the invention is that it can operate wirelessly.

An advantage of the invention is that it can insure the reliability of fuel delivery systems.

Another advantage of the invention is that the generation, reception, processing and classification of ultrasound energy occurs in near real time allowing for the control of external process-control components such as valves and pumping systems.

In one example embodiment a method includes insonifying, using at least one transducer, a vessel using first ultrasound energy of a first frequency, receiving, using the at least one transducer, a first analogue signal obtained using the first ultrasound energy, determining, using processing circuitry, a first material property of the vessel based on a first frequency response signature of the first analogue signal, insonifying, using the at least one transducer, a fluid in the vessel using second ultrasound energy of a second frequency lower than the first frequency, the second ultrasound energy creating cavitation of bubbles in the fluid to be measured, receiving, using the at least one transducer, a second analogue signal obtained using the second ultrasound energy and energy created by the cavitation of the bubbles in the fluid, and identifying, using the processing circuitry, a second material property of the fluid based on the first material property and a second frequency response signature of the second analogue signal.

In some example embodiments the method includes transmitting, using the processing circuitry, a signal with instructions to control a valve or pump based on the second material property of the fluid.

In some example embodiments the method includes selecting the second frequency based on the first material property.

In some example embodiments the vessel is a pipe, the second material property is a flow rate of the fluid, and the method further comprises controlling a valve or pump based on the flow rate.

In some example embodiments the second material property is a detected impurity included in the fluid, and the method includes controlling a valve or pump based on the detected impurity.

In some example embodiments the vessel is a tank, and the method includes transmitting, using the processing circuitry, a signal with instructions to control a pump based on the second material property of the fluid indicating a contaminant in the fluid.

In some example embodiments the first material property is a thickness of walls of the vessel, and the method includes detecting a leak in the vessel based on the first material property and the second material property.

In some example embodiments the first frequency is between 1 and 10 MHz and the second frequency is between 10 and 100 KHz.

In some example embodiments the first material property and the second material property are determined using an artificial neural network.

In some example embodiments the method includes training the artificial neural network using the first frequency response signature and the second frequency response signature.

In another example embodiment a device includes at least one transducer; and processing circuitry. The processing circuitry is configured to insonify, using the at least one transducer, a vessel using first ultrasound energy of a first frequency, receive, using the at least one transducer, a first analogue signal obtained using the first ultrasound energy, determine a first material property of the vessel based on a first frequency response signature of the first analogue signal, insonify, using the at least one transducer, a fluid in the vessel using second ultrasound energy of a second frequency lower than the first frequency, the second ultrasound energy creating cavitation of bubbles in the fluid to be measured, receive, using the at least one transducer, a second analogue signal obtained using the second ultrasound energy and energy created by the cavitation of the bubbles in the fluid, and determine a second material property of the fluid based on the first material property and a second frequency response signature of the second analogue signal.

In some example embodiments the processing circuitry is configured to transmit a signal with instructions to control a valve or pump based on the second material property of the fluid.

In some example embodiments the processing circuitry is configured to select the second frequency based on the first material property.

In some example embodiments the vessel is a pipe, the second material property is a flow rate of the fluid, and the processing circuitry is configured to control a valve or pump based on the flow rate.

In some example embodiments the second material property is a detected impurity included in the fluid, and the processing circuitry is further configured to control a valve or pump based on the detected impurity.

In some example embodiments the vessel is a tank, and the processing circuitry is configured to transmit, using the processing circuitry, a signal with instructions to control a pump based on the second material property of the fluid indicating a contaminant in the fluid.

In some example embodiments the first material property is a thickness of walls of the vessel, and the processing circuitry is configured to detect a leak in the vessel based on the first material property and the second material property.

In some example embodiments the first frequency is between 1 and 10 MHz and the second frequency is between 10 and 100 KHz.

In some example embodiments the first material property and the second material property are determined using an artificial neural network.

In some example embodiments the processing circuitry is configured to train the artificial neural network using the first frequency response signature and the second frequency response signature.

Non-limiting examples of commercial applications for the technology of the present invention can include: fluid turbidity; sizing bubbles in carbonated beverages or supplied CO₂; food contamination; food liquid product quality control, e.g., milk, orange juice; chemical product quality control; food forensics; water content in fuel delivery systems; pharmaceutical and cosmetic product quality; particle sizing; and detecting and measuring gas hydrates, wax and asphaltenes in production oil streams.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram of one many possible embodiments of a system of a fluid quality detection and monitoring system;

FIG. 2 is a block diagram illustrating the interaction among a computing system, signal processing software, and an artificial neural network and a library of fast Fourier transform signals;

FIG. 3 shows a method for creating a library of fast Fourier transform signals, and for using an artificial neural network to determine and monitor fluid quality;

FIG. 4 is a perspective view of one of many possible embodiments of a 2-transducer sensor ring;

FIG. 5 shows examples of fluids capable of being insonified by one or more transducers;

FIG. 6 shows a time-domain response from an ultrasonic emitter/receiver;

FIG. 7 is an illustration of a time domain ultrasound signature signal converted to a frequency response signature;

FIG. 8 depicts two fast Fourier transform signatures showing the difference between two profiles from the two liquid samples with different concentrations of solid particles;

FIG. 9 is a diagram of a 3-layer artificial neural network;

FIG. 10 illustrates identification of ten (10) different concentrations of water in a fuel mixture by an artificial neural network;

FIG. 11 is a flow diagram showing the output of a real-time implementation of one of man possible embodiments of the present invention;

FIG. 12 illustrates an example embodiment of a transducing device;

FIG. 13 illustrates an example embodiment of a vessel with a set of transducing devices attached around the vessel;

FIG. 14 illustrates another example embodiments of a vessel with a set of transducing devices attached around the vessel;

FIG. 15 illustrates an example embodiment of a vessel that is a tank;

FIG. 16 illustrates an example embodiment of a vessel that is a pipe;

FIG. 17 is a flow diagram including operations for operating one or more of the transducing devices.

### DETAILED DESCRIPTION

Ultrasound is generated by a piezoelectric signal emitter, e.g., a transducer, which converts electrical energy to acoustic energy. The piezoelectric emitter can be of any crystal material, such as lead Zirconate Titanate (PZT), lead Metaniobate, composite, etc. In the present application, the ultrasound energy is propagated into a liquid that is subjected to alternating periods of compression and rarefaction of the acoustic pressure wave. The amplitude of the wave decreases with distance due to both energy absorption and scattering. Absorption is a mechanism where a portion of the wave energy is converted into heat, and scattering is where a portion of the wave changes direction due to, in some cases, suspended particles. During rarefaction, gas is drawn out of solution to form bubbles, which can oscillate in size and collapse, i.e., implode, rapidly due, in part, to temperature increases within the microenvironments surrounding the bubbles. The collapse of bubbles creates cavitation throughout the interaction of transmitted ultrasound energy at frequencies characteristic of the fluid. This unique pressure wave is received by a receiving transducer and can be used to identify the fluid and/or characteristics about the fluid.

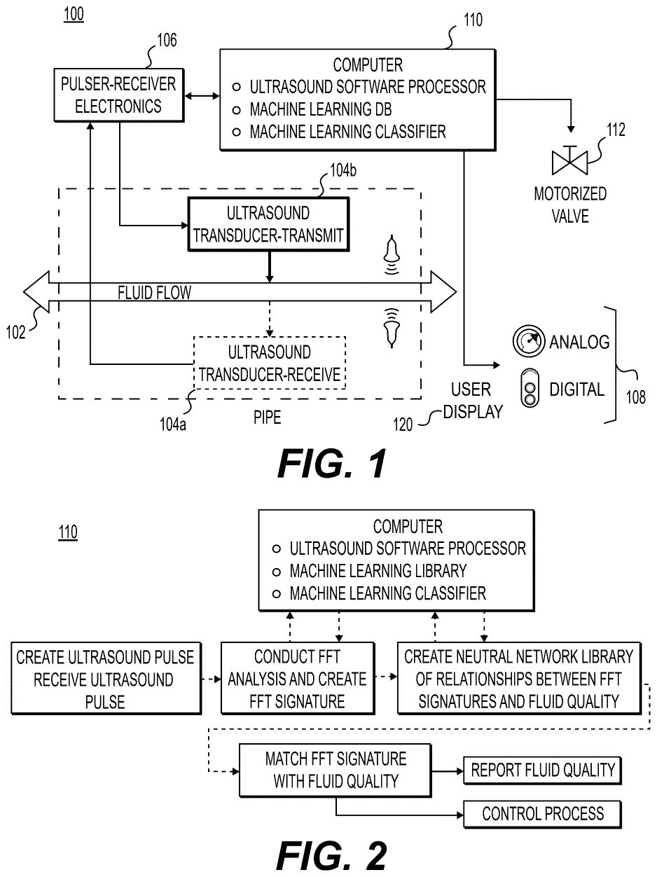

Referring generally to FIG. 1, there is shown a flow diagram representing one of many possible embodiments of a fluid quality classification and monitoring system 100. The system 100 includes an ultrasonic insonification pathway 102 with one or more ultrasonic transducers 104a,b positioned along the ultrasonic insonification pathway 102. The transducers 104a,b optionally, but preferably, are positioned opposite one another, i.e., 180 degrees from each other; however, the insonification process can occur between any two transducers 104a,b at any relative angle from each as long as there is insonified liquid flowing between them. Transducer 104b pulses at one or more frequencies, and transducer 104a receives the pulse. In an alternative embodiment, a single transducer can be used in a pulse-echo mode.

The system 100 can use ultrasound energy in the range from about 20,000 cycles per second (20 kHz) to 7 million cycles per second (7 MHz), although the system 100 is not limited to a particular frequency range and can operate at frequencies well above 20 MHz. A preferred frequency range is between about 500 kHz and 50 MHz, with a most preferred range being between about 500 kHz and 5 MHz. The concentration of fluid being identified or monitored can be within a wide range of densities and specific gravities. The ultrasonic frequencies and amplitudes can be adjusted to penetrate high density and low density fluid solutions, such as coal slurry (high density) and distilled water (low density). The ultrasonic frequencies and amplitude can be adjusted as necessary to penetrate or reflect off of low and high density particulates and solids such as fine sand or stone particles.

As fluid flows between the transducers 104a,b, a programmed general purpose computer 110 can be used to digitize the acquired analogue signals and to create time domain ultrasound signature. Alternatively, an analog-to-digital converter 108 can be networked to the system 100. Time domain ultrasound signatures can range from a few microseconds to milliseconds. The time domain ultrasound signal quality is disrupted by the physical quality of the liquid that is present between the emitter and receiving transducers 104a,b. The fluid can be stagnant or flowing.

The transducers 104a,b optionally but preferably are interfaced to ultrasonic transmit and receive electronics 106 that provide pulse and receive signal power. The ultrasound transmit and receive electronics 106 can include a board that creates a pulse and sends it via a wire to the transducer 104b. The board in the ultrasound transmit and receive electronics 106 can then receive a return signal from transducer 104a and transmit the returned signal to computer 110 through a USB port or wirelessly. The pulser-receiver board in the ultrasonic transmit and receive electronics 106 can get its power from the USB interface with the computer 110. Alternatively, the pulser-receiver board in the ultrasonic transmit and receive electronics 106 can be integrated into the same housing as the computer 110. The computer 110 can be any specially programmed general purpose computer. In an alternative embodiment, the computer 110 can be a portable Raspberry Pi.

The transmit and receive electronics 106 receive the return signal from transducer 104a in the analogue domain. The returned signal can be converted from analogue to digital by computer 110, or the transmit and receive electronics 106 can transmit the return signal to an analogue-to-digital converter 108 for conversion. The computer 110 can be used for digitizing, filtering and processing the signal from the analogue-to-digital converter 108. The computer 110 can be used to control the functioning of a valve 112 or pump on industrial equipment integrated with the system 100.

The analogue to digital converter 108, or alternatively the computer 110, converts the time domain ultrasound signature into a frequency domain signature with the use of a fast Fourier Transform (FFT) in order for the computer 110 to develop a frequency response unique to the fluid that has been insonified. The FFT of the insonified fluid between the transducers 104a,b characterizes a unique frequency response signature that represents the amplitude, i.e., voltage or power, for each frequency in the generated frequency spectrum.

An FFT algorithm is used to convert components of a returned signal, in this case turbulence and cavitation, from its time domain to a representation in the frequency domain. There are a number of different types of FFT formulas but the most common one used for discrete Fourier analysis is noted below and is used in the current embodiment of the fluid classification and monitoring system 100:

$${X}_{k} = {\sum }_{n = 0}^{N - 1} {x}_{n} {e}^{- i 2 π k \frac{n}{N}} k = 0 , … , N - 1.$$

The time domain ultrasound signature shows the travel of the acoustic energy from one transducer to another located at or within a 180 degrees half-concentric circle from the transmitting transducer. The resultant FFT is computed from the time domain ultrasound signature. By measuring sound energy within the captured frequency spectrum, a unique frequency response signature is created and associated with the fluid flowing between the two transducers 104a,b. Unique amplitude/frequency profiles are created that represent specific characteristics of the fluid such as: suspended solids; size of organic or inorganic particle droplets; entrapped air in the form of bubbles; oil, polymer and colloidal concentrations, etc. These profiles can then be used as a reference to identify similar characteristics in other fluids to be monitored.

In addition to the unique frequency response signature created, the overall acoustic power of the profiles defined as the root mean square (RMS) of the energy can be used to characterize each profile such that acoustic energy that is reduced between the gradient of the two transducers 104a,b results in attenuation of energy which is used by an artificial neural network (ANN) to classify the fluids.

After the fluid time domain signals are acquired, the fluid frequency response signatures are then used to train an artificial neural network (ANN). Each digitized frequency/amplitude (F/A) profile is considered an input to an ANN to generate a library of frequency response signatures. For instance, a liquid that contains suspended solids will create a degree of turbidity. Degrees of turbidity can range from 0 NTU (Nephelometric Turbidity Unit) to over 100 NTUs (lack of optical transparency). NTU is a unit of measurement for determining the clarity of a fluid, or the extent of the presence of suspended particles in water. High concentrations of suspended solids in a fluid results in less optical transparency and is tagged with a high NTU value. Each degree of turbidity has a unique frequency response signature. Such profiles become inputs to an ANN, which is “trained” through traditional neural network protocol. This relationship between the F/A profile and NTU values become the components of the ANN library against which future liquid samples are compared and classified into their likely turbidity, or NTU, category. The creation of a frequency response signature library for any type of fluid is not limited to a particular ANN architecture.

The ANN is taught how to classify a particular fluid quality such as the density of a water-sand mixture by acquiring samples of the time domain signal associated with different fluids; converting the time domain signals into frequency domain signals to establish distinct FFT signatures for each fluid; teaching an ANN to distinguish individual fluids to establish a library of signatures associated with a range of fluids.

ANNs are mathematical models designed to loosely resemble the human nervous system or, more specifically, the connectivity among neurons within the brain. ANNs have the ability to learn relationships between groups of data by “seeing” many examples of the data. The learning process depends on many examples and accurate feedback. ANNs are able to learn relationships between real-world data and the underlying cause by looking at many specific instances and receiving feedback regarding the error associated with hitting a target.

ANNs learn by the same learning scheme, called supervised learning, that guides much of human learning. There are many neural network supervised learning schemes available. The most common and the one used in this invention is the backpropagation method made popular by Rumelhart, McClelland, and Williams. For an ANN to use backpropagation it must be able to accept data in the form of an input to the ANN system, respond with an answer in the form of a system output, and determine the accuracy of the response. The further the network's response is from the desired target, the greater the changes it needs to make to learn the proper association between the input and the output.

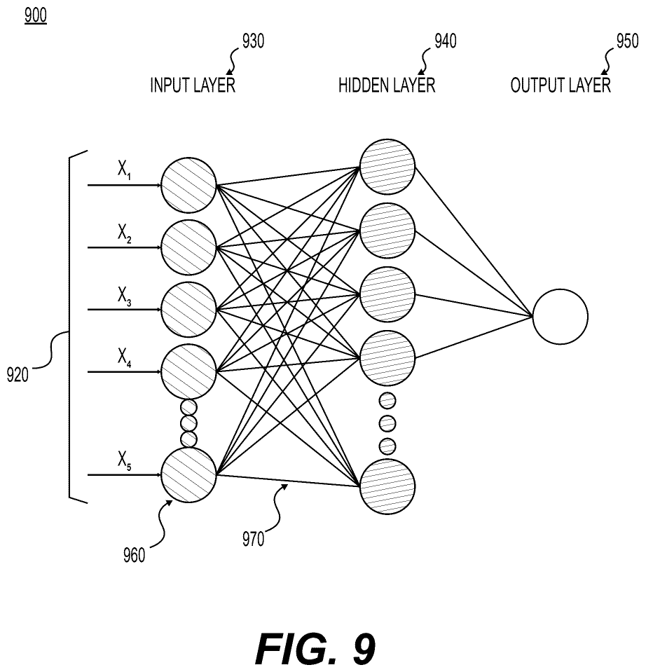

In reference to the present invention, the ANN 900 backpropagation algorithm receives the frequency response signature data 920 which represents the ANN's input layer 930 as shown in FIG. 9, which represents a three layer network: an input layer 930, a hidden layer 940, and an output layer 950. The nodes 960 on the layers 930, 940, 950 are joined by weighted connections 970 as shown by the lines between nodes 960. Each connection 970 has a value associated with it called a weight. The ANN 900 reads the FFT input data 920 represented by a fluid sample, in the case of the present application. The network processes the data 920 using the values of the connecting weights 970 and eventually produces an output 950 that is a numerical value or textual representation of the input sample. Initially, these connecting weights 970 are set to random values within the weight initialization range. The object of training an ANN is to determine the values of the weights associated with the particular fluid sample which will produce the correct output for each given FFT input signature.

The current invention is not limited to the number of input/output values or layers necessary to achieve a desired solution. Furthermore, the ability of the invention to perform is not limited to any particular architecture processing approach, e.g. forward or backward pass transfer functions. The ability of the network to discriminate the FFT signatures among multiple degrees of fluids, can be achieved by different ANN layers and transfer functions.

As shown in FIG. 1, the output of the system 100 can be accessed by an operator through a user interface 120 to obtain real-time information regarding the fluid quality in the form of turbidity, solids density, presence or absence of contaminants, e.g., water in fuel, product purity, and particle distribution. The display of information can be in the form of analog information, digital information or information that controls a process such as a valve 112 or pump. The active control of an industrial process function can be achieved through a standard programmable industrial logic controller.

Referring generally to FIG. 2, there is shown an embodiment of the computing system 110, which contains signal processing software and data storage capabilities including ANN libraries required to store the frequency response signature characteristics of the stored fluid quality profiles. The computer code can comprise any software or firmware capable of controlling the timing of the transmitted and received pulses, converting the time domain signatures to frequency response signatures, and storing the output data.

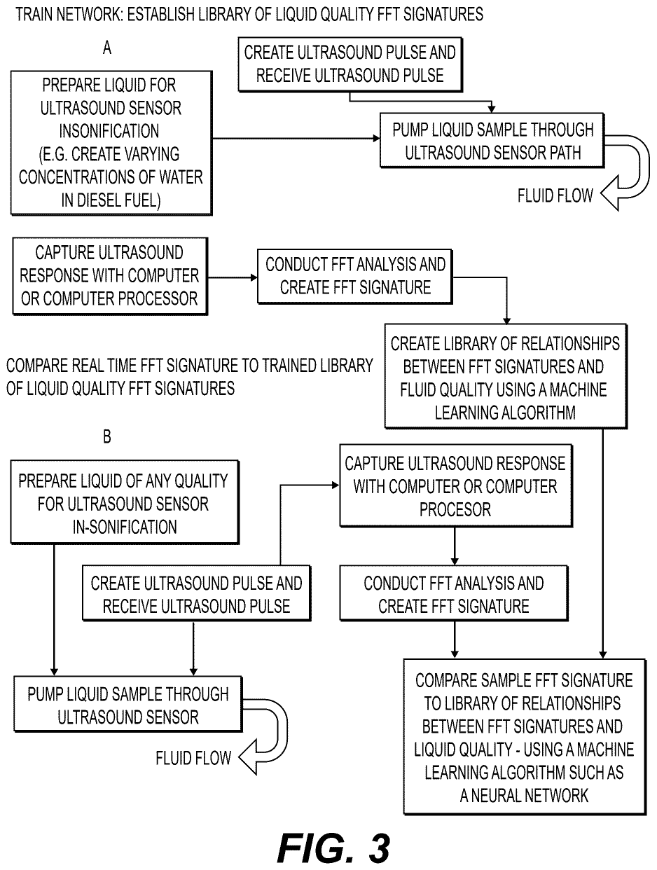

As shown in FIG. 3 the ANN data storage section is organized into two sections: an FFT-created a priori ANN library containing the results of previous ANN training results and the current real-time data buffer with fluid quality FFT signatures which are to be compared to the static FFT-created a priori ANN reference library.

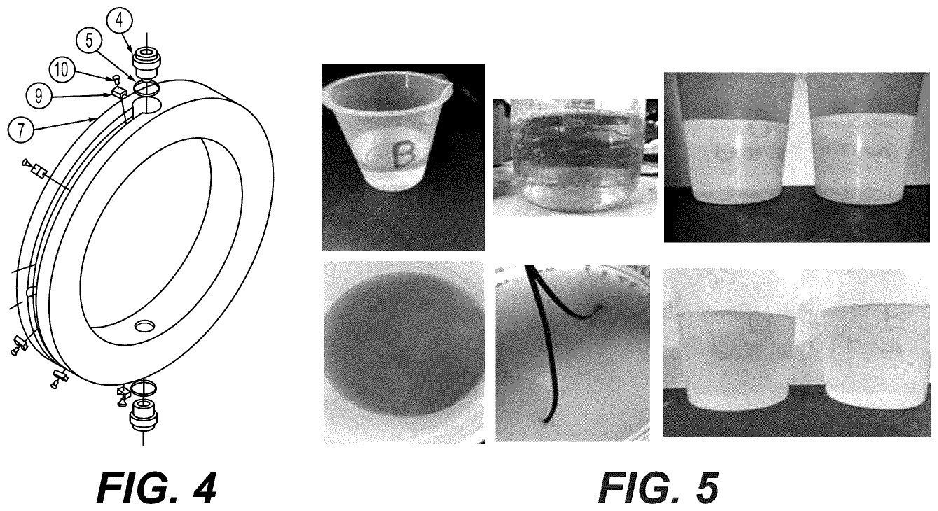

Referring generally to FIG. 4, two or more ultrasonic transducers are located across from each other at any distance, and in the present example the transducers are integrated into a ring or insert that can be interfaced through two pipe flanges within a processing control application. The position of the transducers can be anywhere within the 180 degrees. As noted earlier; however, the insonification process will occur between the two transducers at any relative angle from each other. The transducers can be constructed using PZT, Composite or similar piezoelectric transducers.

Referring generally to FIG. 5, a wide variety of liquids can flow between the transducers in order to train an ANN and create a library of frequency domain signatures. The transducers can be located on the outside of a pipe, tank, vessel or within a fluid filled structure of any inside diameter.

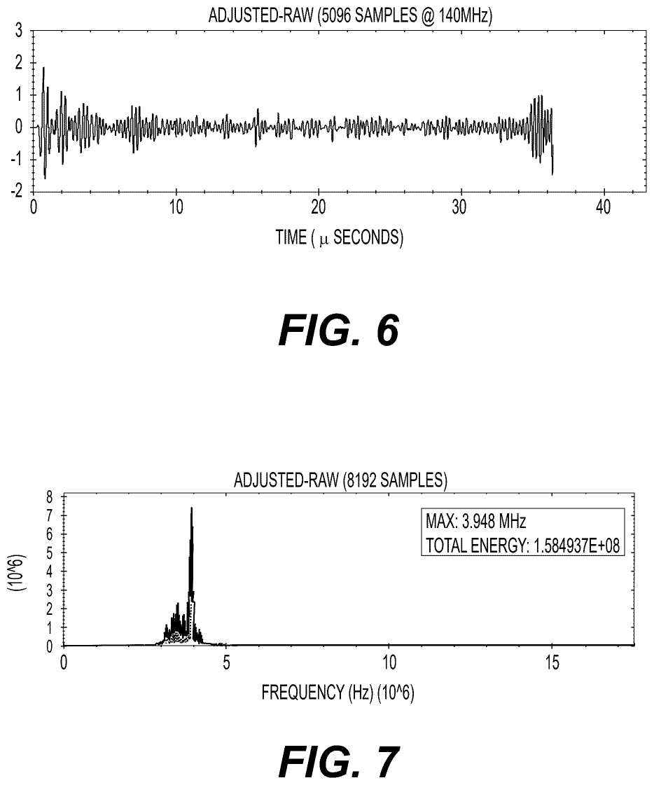

Referring to FIG. 6, there is shown a time domain ultrasound signature generated by scanning fluid from FIG. 5 using the ultrasound send/receive transducers.

Referring generally to FIG. 7, the time domain ultrasound signature shown in FIG. 6 has been converted into a frequency domain signature and displayed as an FFT.

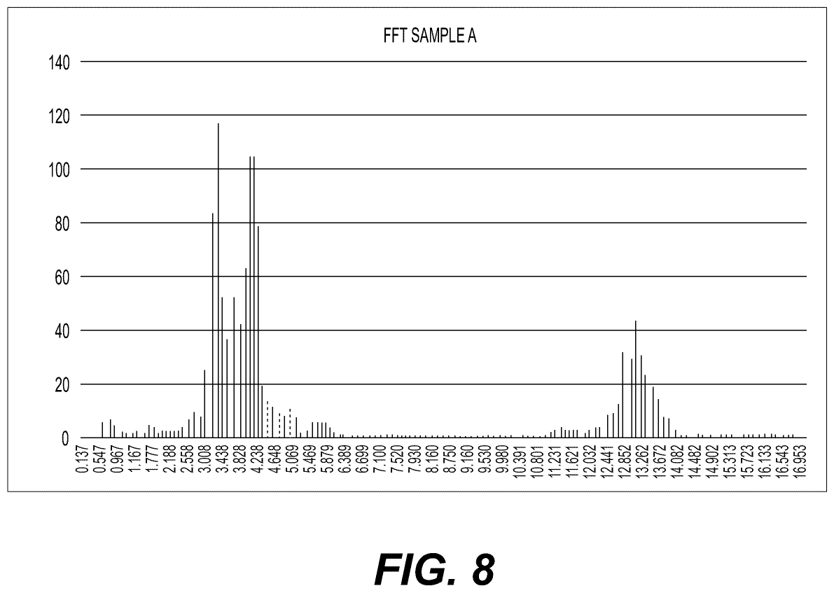

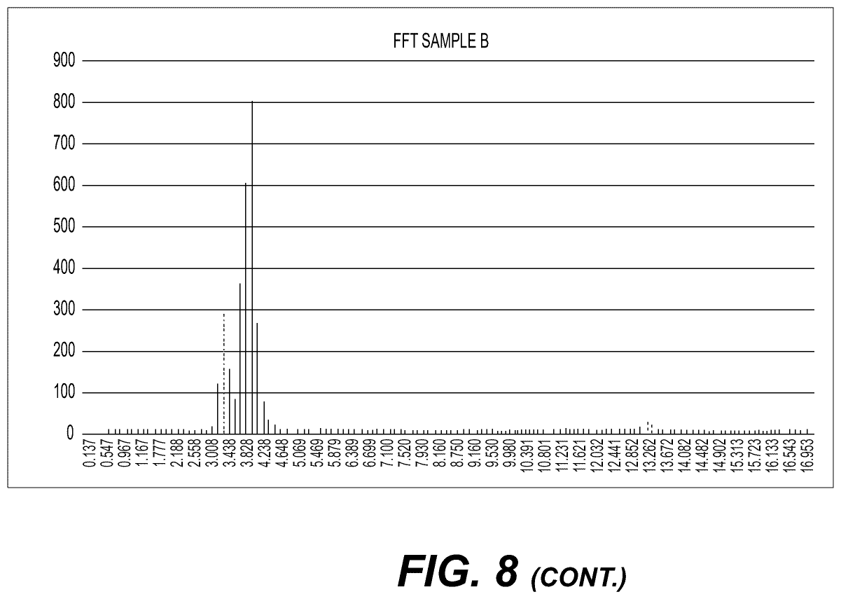

Referring generally to FIG. 8, two FFT profiles can be created by subjecting two different fluids to the ultrasound send/receive transducers and electronics. The signature profiles have uniquely different frequency response characteristics due to the difference in the content of the fluids. Unique libraries of FFT-generated signatures can include, but are not limited to, fluid turbidity, solids concentration, percent concentration of water and fuel mixtures, consumable fluid products including potential degrees of contamination, fluid salt concentrations and carbon dioxide concentrations.

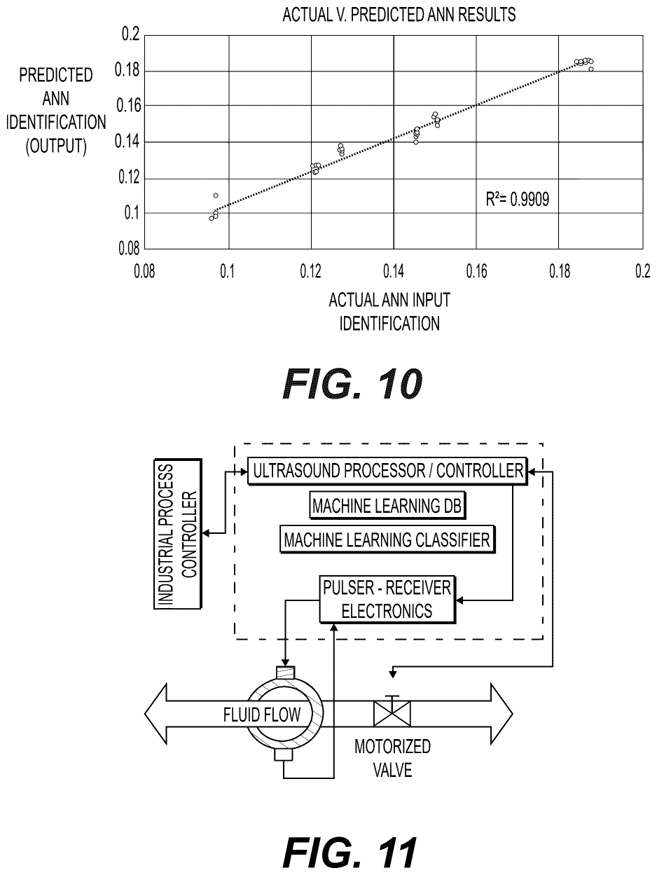

As shown in FIG. 10, the classification performance of the ANN using new data streams is very accurate when compared to the previously-created FFT-created a priori ANN library. The performance is demonstrated by the +99.9 percent best fit trend line.

As shown in FIG. 11, in the case of a real-time process control implementation, the output of the ANN can discretely or proportionally control a valve for the diversion control of fluid flow; for chemical treatment control, for flow diversion or similar applications where real time, precise control of fluid/fluid-solids processes is necessary.

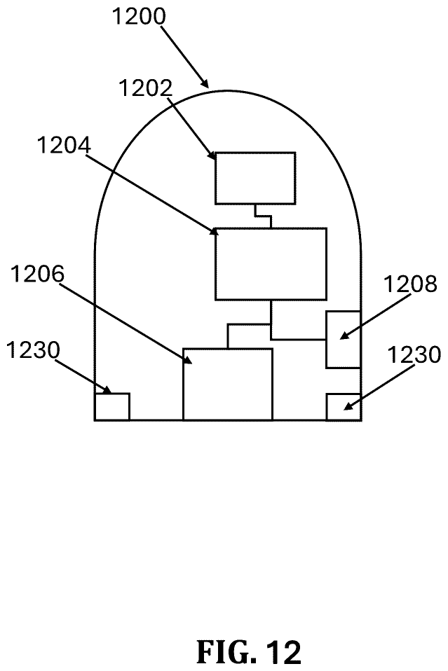

FIG. 12 illustrates an example embodiment of a transducing device 1200. The transducing device 1200 includes a memory 1202, a processor 1204, a transducer 1206, communication hardware 1208, and couplers 1230. The transducing device 1200 may also include other elements such as housing, wiring and other related components. The memory 1202 may include any of random access memory, hard disk drive, and solid state drive. The processor 1204 may include any of a central processing unit, an arithmetic logic unit, a microprocessor, and controller. The memory 1202 and processor 1204 may jointly be referred to as processing circuitry. Other examples of processing circuitry which may replace processor 1204 and memory 1202 or be additionally included in the transducing device 1200, may include field programable gate arrays, programable logic and application specific integrated circuit.

The transducer 1206 may be an ultrasonic transducer configured to generate vibrations in a range of 10 Khz to 10 Mhz. The transducer 1206 may generate the vibrations by using an electric current to vibrate a magnet at the rate of 10 KHz to 50 MHz. The vibration energy may be referred to as ultrasound energy. The transducer 1206 may be configured to directly contact a vessel 1300 such as a pipe or tank so that the ultrasound energy is transferred directly into the vessel 1300 (e.g., the ultrasound energy is not primarily delivered via the air but is delivered through physical connection to the transducing device 1200).

The communication hardware 1208 may include hardware for wired or wireless communications. The wireless communications may include, wireless local area network communication (Wifi), Bluetooth communication, radio communication or other communication using electromagnetic radiation. The wired communications may include wire communication, coaxial line communication, and fiberoptic communication. The communication hardware way be used to communicate with servers, actuators (for pumps and valves or the like), controllers, computers, etc.

The couplers 1230 may secure the transducing device 1200 to the vessel 1300. The couplers 1230 may include any of, magnets, screws, bolts, rivets, adhesive, straps, or other hardware which secures the transducing device 1200 to the vessel 1300 such that the transducing device 1200 does not move relative to the vessel 1300.

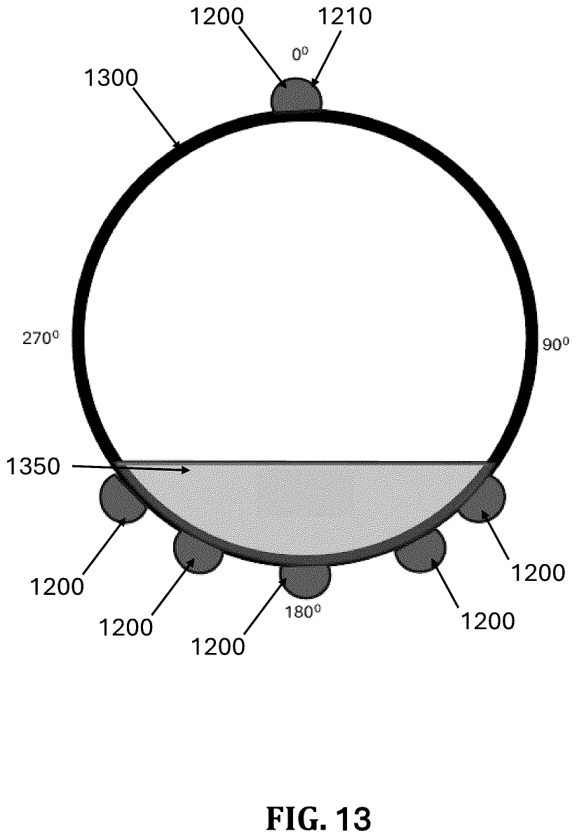

FIG. 13 illustrates an example embodiment of a vessel 1300 with a set of transducing devices 1210 attached around the vessel 1300. The vessel 1300, shown in FIG. 13, is circular in cross section. In other embodiments the vessel may have a different shape such as an oval, or rectangular shape. The vessel 1300 may be a tank or a pipe or other hardware containing fluid. The vessel may be made of metal (such as copper or steel) or plastic (such as polyvinyl chloride) The set of transducing devices 1210 may include one transducing device 1200 on the top of the vessel 1300 and five transducing devices 1200 on the bottom side of the vessel 1300. The transducing devices 1200 on the bottom side of the vessel 1300 may be spread out evenly throughout the bottom about 90 degrees of the vessel 1300. Each of the transducing devices 1200 in the set of transducing devices 1210 may be connected together with a wired or wireless connection such that communication between the transducing devices 1200 is enabled. The transducing devices 1200 may communicate with each other to enable a determination of a material property of the fluid in the vessel 1300 or the material of the vessel 1300. For example, the transducing device 1200 at the bottom of the vessel (i.e. at 1800 as shown in FIG. 13) may emit ultrasonic energy, the other transducing devices 1200 in the set of transducing devices 1210 may act as receivers to receive the ultrasonic energy transmitted through the vessel 1300 and fluid 1350.

In some embodiments, first transducing devices 1200 among the transducing devices may be high frequency transducing devices which are configured to emit high frequency ultrasonic energy (e.g., 1=10 MHz) and second transducing devices 1200 among the transducing devices may be low frequency devices which are configured to emit lower frequency ultrasonic energy (e.g., 10-100 KHz). All of the transducing devices may be able to receive and record high and low energy ultrasonic energy (ultrasonic energy from the first and second ultrasonic transducers 1200). The high frequency transducers mat be configured to send signals to control the second transducers 1200 to adjust the optimum frequency of the second transducers 1200.

The transducing devices 1200 in the set of transducing devices 1210 may communicate with each other and or outside processing circuitry to share the information on the received ultrasonic energy so a determination can be made of the material property of the vessel 1300 and/or fluid 1300. Examples of material properties of the vessel 1300 which may be determined are material type, material quality (e.g., existence of corrosion or scoring), and material thickness. Examples of material properties of the fluid 1350 which may be determined are fluid level, fluid composition (including presence of impurities), and fluid flow rate.

Additional determinations may also be made based on the material properties of the vessel 1300 and the fluid 1350. For example, if the vessel's 1300 material thickness is determined to be thin (e.g., under 1 mm) and the fluid 1350 is determined to have contaminants of water (the fluid being primarily diesel or another hydrocarbon) it may be determined that the vessel 1300 is allowing water to enter the vessel 1300. In response to this determination, at least one of the transducing devices 1200 in the set of transducing devices 1210 may communicate with a pump or valve to prevent additional fluid from being pumped into the vessel. At least one of the transducing devices 1200 in the set of transducing devices 1210 may communicate a warning to a control device or other device.

The transducing devices may determine that a fluid being pumped into the vessel 1300 does not match a fluid in the vessel (e.g., diesel being pumped into a gasoline tank) and communicate with a pump or valve to prevent further contamination.

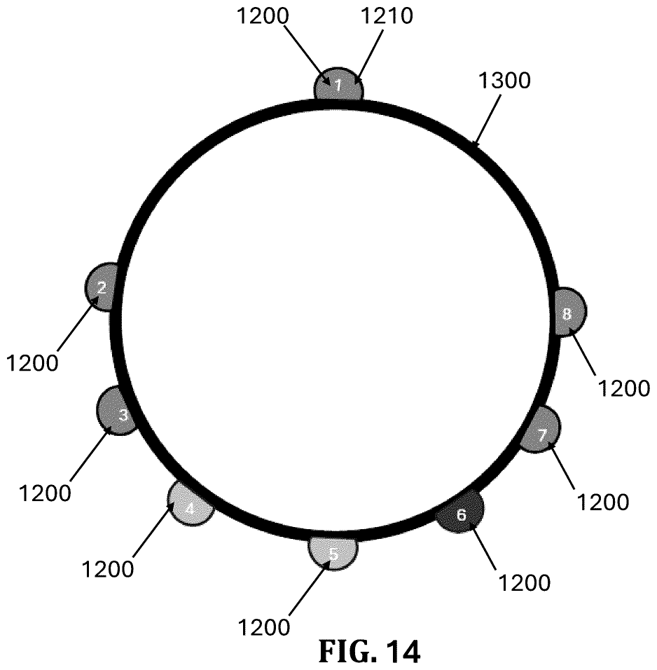

FIG. 14 illustrates another example embodiments of a vessel 1300 with a set of transducing devices 1210 attached around the vessel 1300. In this example embodiment, the set of transducing devices includes one transducing device 1200 on the top of the vessel 1300 and five transducing devices 1200 on the bottom half of the vessel 1300. The transducing devices 1200 on the bottom half of the vessel 1300 may be spread out evenly throughout the bottom about 180 degrees of the vessel 1300.

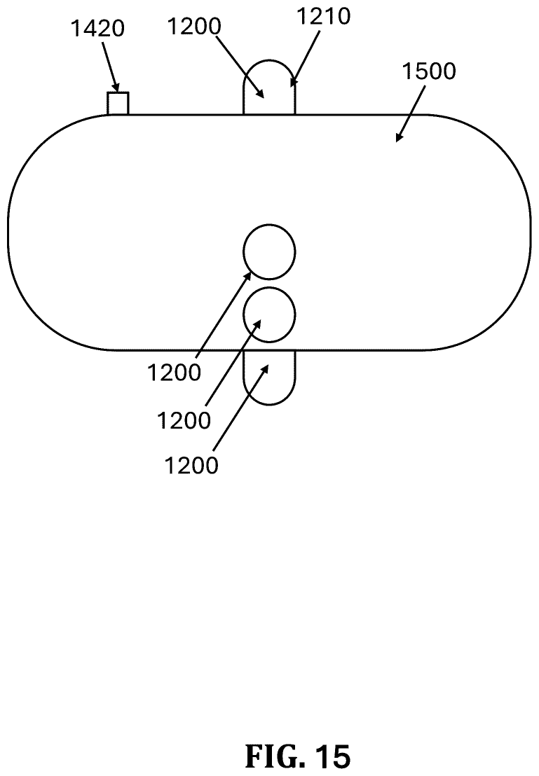

FIG. 15 illustrates an example embodiment of a vessel 1500 that is a tank. The vessel 1500 includes one set of transducing devices 1210 around a middle of the vessel 1500. The vessel 1500 may include a valve 1420 which can be closed using an electric motor turning a stopper or similar hardware. A pump or other related hardware used for filling or emptying the vessel may also be included.

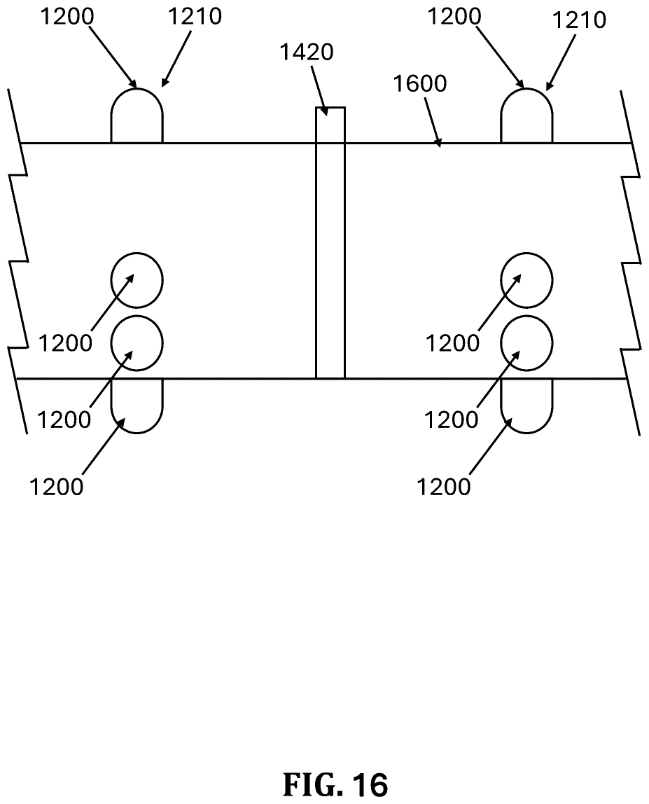

FIG. 16 illustrates an example embodiment of a vessel 1600 that is a pipe. The vessel 1600 may include multiple sets of transducing devices 1210 at regular intervals on the vessel 1600. The vessel 1600 may include a valve 1420 which includes a portion in the pipe which can be rotated to stop flow of fluid or rotated to allow flow of fluid in the pipe. The valve 1420 may include an electric motor to rotate the portion of the valve inside the pipe. If a contaminant is detected in the pipe, a signal may be sent to close the valve 1420 so the contaminant does not flow into other sections of the vessel 1600.

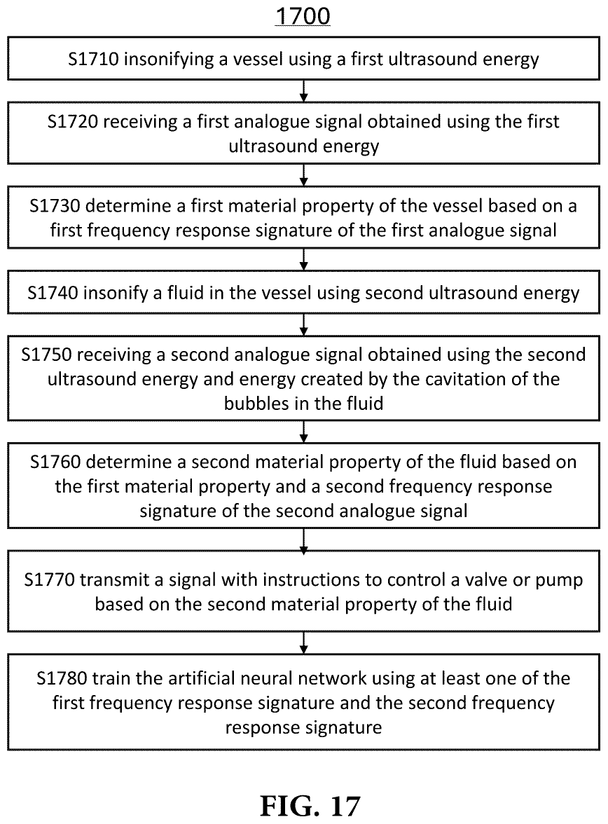

FIG. 17 is a flow diagram 1700 including operations for operating one or more of the transducing devices. At S1710, at least one of the transducing devices 1200 may insonify the vessel 1300 with a first ultrasound energy. The first ultrasound energy may be at a first frequency (about 1-10 MHz which allows for better detection of the material properties of the vessel 1300. In one example, the first frequency is 3.5 MHz. The transducing device 1200 may directly apply the ultrasound energy to the vessel 1300, e.g., through direct physical contact with the vessel 1300 and not primarily through the air.

At S1720, at least one of the transducing devices 1200 may receive a first analogue signal obtained using the first ultrasound energy. The receiving transducing device may be the same as the insonifying transducing device or may be one or mor other transducing devices. For example, one transducing device 1200 in a set of transducing devices 1210 may insonify the vessel and all the transducing devices 1200 in the set of transducing devices 1210 may receive the first ultrasound energy as analogue signals.

At S1730, a material property of the vessel may be determined, using processing circuitry, based on a first frequency response signature of the first analogue signal. In a case where multiple transducing devices receive the first ultrasound energy as analogue signals, each of the received analogue signals may be used to determine the material property of the vessel 1300. For example, an ANN which has been trained to determine material properties of a vessel 1300 may be used to determine a material property of the vessel 1300. A plurality of ANNs may be each trained for a different material property of the vessel 1300, such as material composition, material thickness, material corrosion, material damage (such as scoring). Each may be used to determine material properties of the vessel 1300. Alternatively, one ANN may be trained to determine each of these material properties of the vessel 1300.

At S1740, at least one transducing device 1200 may insonify the fluid in the vessel 1300 using second ultrasound energy transmitted through the vessel 1300. The second ultrasound energy may be transmitted at a frequency which allows for better detection of the material properties of the vessel 1300. In one example, the second frequency is 10-100 KHz. The first frequency may be selected based on a thickness of the material of the vessel 1300. For example, the determined material property of the vessel 1300 may be the thickness of the vessel 1300 (i.e., how thick the walls of the vessel 1300 are). A transit pulse wavelength may be calculated based on the material thickness of the vessel 1300. The transit pulse wavelength may be a wavelength with a quarter wave phase angle beyond the inner (back) wall of the material (measured from the interface between the transducing device 1200 and the vessel 1300) and using the speed of sound of the material. The transit pulse wavelength may be calculated as a wavelength with a quarter wave phase angle up to 25% (of the width of the material) beyond the inner (back) wall of the material, preferably about 5% beyond the inner wall of the material. Higher frequencies can provide greater resolving power and less scattering and noise from the vessel wall, therefore the frequency may be selected to be close (i.e., with a quarter wave phase angle up to 25% of the width of the material) to the frequency of the wavelength with the quarter wave phase angle at the inner (back) wall of the material. The frequencies with a wavelength with a quarter wave phase angle beyond the inner (back) wall of the material pass through hard vessel materials such as metal and plastic without much attenuation. However, there is some attenuation which occurs which affects the frequency response of ultrasound energy. This insonification may create cavitation in bubbles in the fluid 1350. The wall thickness may change over time as the material of the vessel 1300 wears or corrodes. The selection of frequency may be performed frequently. For example, the measurements of the thickness of the material of the vessel 1300 and the selection of the frequency may be performed at regular intervals (such as daily), or each time the second ultrasound energy is to be emitted.

At S1750, at least one of the transducing devices 1200 may receive a second analogue signal obtained using the second ultrasound energy and energy created by the cavitation of the bubbles in the fluid. The receiving transducing device may be the same as the insonifying transducing device or may be one or mor other transducing devices. For example, one transducing device 1200 in a set of transducing devices 1210 may insonify the vessel and all the transducing devices 1200 in the set of transducing devices 1210 may receive the first ultrasound energy as analogue signals.

At S1760, a material property of the fluid may be determined, using processing circuitry, based on a second frequency response signature of the second analogue signal and the first material property of the vessel. In a case where multiple transducing devices 1200 receive the first ultrasound energy as analogue signals, each of the received analogue signals may be used to determine the material property of the fluid 1300. For example, an ANN which has been trained to determine material properties of a fluid 1350 may be used to determine a material property of the fluid 1350. A plurality of ANNs may be each trained for a different material property of the fluid 1350, such as fluid level, fluid constitution (including impurities), and flow rate. The ANNs may be trained with data including material properties of the vessel through which the second analogue signal is received and transmitted. The material properties of the vessel affect the frequency response signature (for example attenuation levels change based on material type and material thickness of the vessel and corrosion may cause reflections different from smooth surfaces). The ANN by being trained using the material properties of the vessel improves the accuracy the determination of the material properties of the fluid 1350. Each ANN may be used to determine material properties of the fluid 1350. Alternatively, one ANN may be trained to determine each of the material properties of the fluid 1350.

At S1770, the processing circuitry may transmit a signal including instructions to control a valve or pump based on the second material property of the fluid. For example, a signal controlling the valve 1420 to close the valve 1420 in response to a determination of a contaminant in the fluid 1350. The processing circuitry may also transmit warning signals to external devices to inform operators of the determined material properties of the fluid 1350 and/or vessel 1300. For example, if the vessel 1300 is a storage tank storing lubricant and an impurity of water is detected in the tank, a signal controlling to control a pump to stop pumping contaminated lubricant is sent. Thus, a signal may be sent with instructions to control a pump based on the second material property of the fluid indicating a contaminant in the fluid.

At S1780, the processing circuitry may further train the ANN(s) using at least one of the first frequency response signature and second signature response signature. For example, the ANN for determining the fluid consistency of the fluid 1350 may be trained using the first frequency response signature and the ANN for determining the material thickness of the vessel 1300 may be trained using the second frequency response signature. This training may improve the future prediction performance of the ANN(s).

Terms such as “about,” “nearly,” and “substantially” should be interpreted as meaning a plus or minus 10% window around the specified value unless otherwise specified.

### CONCLUSION

While various embodiments of the present invention have been described above, it should be understood that they have been presented by way of example only, and not limitation. It will be understood by those skilled in the art that various changes in form and details may be made therein without departing from the spirit and scope of the invention. Thus, the breadth and scope of the invention should not be limited by any of the above-described exemplary embodiments.

What is claimed is:

1. A method comprising:
insonifying, using at least one transducer, a vessel using first ultrasound energy of a first frequency;
receiving, using the at least one transducer, a first analogue signal obtained using the first ultrasound energy;
determining, using processing circuitry, a first material property of the vessel based on a first frequency response signature of the first analogue signal;
insonifying, using the at least one transducer, a fluid in the vessel using second ultrasound energy of a second frequency lower than the first frequency, the second ultrasound energy creating cavitation of bubbles in the fluid to be measured;
receiving, using the at least one transducer, a second analogue signal obtained using the second ultrasound energy and energy created by the cavitation of the bubbles in the fluid; and
identifying, using the processing circuitry, a second material property of the fluid based on the first material property and a second frequency response signature of the second analogue signal.

2. The method of claim 1, further comprising:
transmitting, using the processing circuitry, a signal with instructions to control a valve or pump based on the second material property of the fluid.

3. The method of claim 1, further comprising:
selecting the second frequency based on the first material property.

4. The method of claim 1, wherein
the vessel is a pipe,
the second material property is a flow rate of the fluid, and
the method further comprises controlling a valve or pump based on the flow rate.

5. The method of claim 1, wherein
the second material property is a detected impurity included in the fluid, and
the method further comprises controlling a valve or pump based on the detected impurity.

6. The method of claim 1, wherein
the vessel is a tank, and
the method further comprises transmitting, using the processing circuitry, a signal with instructions to control a pump based on the second material property of the fluid indicating a contaminant in the fluid.

7. The method of claim 1, wherein
the first material property is a thickness of walls of the vessel, and
the method further comprises:
detecting a leak in the vessel based on the first material property and the second material property.

8. The method of claim 1, wherein the first frequency is between 1 and 10 MHz and the second frequency is between 10 and 100 KHz.

9. The method of claim 1, wherein the first material property and the second material property are determined using an artificial neural network.

10. The method of claim 9, further comprising: training the artificial neural network using the first frequency response signature and the second frequency response signature.

11. A device comprising:
at least one transducer; and
processing circuitry configured to
insonify, using the at least one transducer, a vessel using first ultrasound energy of a first frequency;
receive, using the at least one transducer, a first analogue signal obtained using the first ultrasound energy;
determine a first material property of the vessel based on a first frequency response signature of the first analogue signal;
insonify, using the at least one transducer, a fluid in the vessel using second ultrasound energy of a second frequency lower than the first frequency, the second ultrasound energy creating cavitation of bubbles in the fluid to be measured;
receive, using the at least one transducer, a second analogue signal obtained using the second ultrasound energy and energy created by the cavitation of the bubbles in the fluid; and
determine a second material property of the fluid based on the first material property and a second frequency response signature of the second analogue signal.

12. The device of claim 11, wherein the processing circuitry is further configured to transmit a signal with instructions to control a valve or pump based on the second material property of the fluid.

13. The device of claim 11, wherein the processing circuitry is further configured to select the second frequency based on the first material property.

14. The device of claim 11, wherein
the vessel is a pipe,
the second material property is a flow rate of the fluid, and
the processing circuitry is further configured to control a valve or pump based on the flow rate.

15. The device of claim 11, wherein
the second material property is a detected impurity included in the fluid, and
the processing circuitry is further configured to control a valve or pump based on the detected impurity.

16. The device of claim 11, wherein
the vessel is a tank, and
wherein the processing circuitry is further configured to transmit, using the processing circuitry, a signal with instructions to control a pump based on the second material property of the fluid indicating a contaminant in the fluid.

17. The device of claim 11, wherein
the first material property is a thickness of walls of the vessel, and
the processing circuitry is further configured to detect a leak in the vessel based on the first material property and the second material property.

18. The device of claim 11, wherein the first frequency is between 1 and 10 MHz and the second frequency is between 10 and 100 KHz.

19. The device of claim 11, wherein the first material property and the second material property are determined using an artificial neural network.

20. The device of claim 19, the processing circuitry is further configured to train the artificial neural network using the first frequency response signature and the second frequency response signature.
